(19) United States
(12) Patent Application Publication
(10) Pub. No.: US 2022/0103036 A1
(43) Pub. Date: Mar. 31, 2022

(54) YOKE FOR ROTOR OF AXIAL GAP MOTOR

(71) Applicant: NICHIA CORPORATION, Anan-shi (JP)

(72) Inventors: Kohei IHARA, Tokushima-shi (JP); Masahiro ABE, Tokushima-shi (JP); Rie YOSHIDA, Anan-shi (JP); Satoshi YAMANAKA, Tokushima-shi (JP)

(73) Assignee: NICHIA CORPORATION, Anan-shi (JP)

(21) Appl. No.: 17/449,023

(22) Filed: Sep. 27, 2021

(30) Foreign Application Priority Data
Sep. 29, 2020 (JP) 2020-163865
Sep. 10, 2021 (JP) 2021-147703

(51) Int. Cl. H02K 1/27; H02K 21/24

(52) U.S. Cl. CPC H02K 1/2793; H02K 21/24

(57) ABSTRACT

A yoke for a rotor of an axial gap motor, having a plurality of recesses at a surface to be bonded to a bonded magnet, at least one of the recesses penetrating the yoke radially to an inner periphery or an outer periphery, wherein a maximum width of an inside part of at least one of the recesses is larger than that of an open part of the recess.

### CROSS-REFERENCE TO RELATED PATENT APPLICATION

This application claims priority to Japanese Patent Application No. 2020-163865 filed on Sep. 29, 2020, and Japanese Patent Application No. 2021-147703 filed on Sep. 10, 2021. The disclosures of Japanese Patent Application No. 2020-163865 and Japanese Patent Application No. 2021-147703 are hereby incorporated by reference in their entirety.

### BACKGROUND

### Technical Field

The present invention relates to a yoke for a rotor of an axial gap motor, and a rotor of an axial gap motor including the yoke.

### Description of Related Art

Thin axial gap motors capable of producing high torque are known. Such motors are provided with rotors each including a yoke and a rotor magnet. For example, JP 2016-131468 A discloses a yoke in which a plurality of grooves are provided in the circumferential direction in the surface to be bonded to a rotor magnet. Here, a bonded magnet is directly injection-molded onto the yoke to produce a rotor.

In JP 2016-131468 A, however, the structure and number of the grooves are not considered. A defect such as peeling of the bonded magnet from the yoke or cracking of the bonded magnet may therefore occur in a severe use environment in which low and high temperatures are repeated, such as in a water pump or fuel pump in a vehicle.

### SUMMARY

The present disclosure aims to provide a highly durable rotor of an axial gap motor which makes it possible to reduce defects such as peeling and cracking of a bonded magnet even in a use environment in which low and high temperatures are repeated (hereinafter, in a cold-hot environment), as well as a yoke suitable for the rotor of an axial gap motor.

Embodiments of the present invention relate to a yoke for a rotor of an axial gap motor, having a plurality of recesses at a surface to be bonded to a bonded magnet, at least one of the recesses penetrating the yoke radially to an inner periphery or an outer periphery, wherein a maximum width of an inside part of at least one of the recesses is larger than that of an open part of the recess. According to an exemplary embodiment, each of the recesses penetrates the yoke radially to an inner periphery or an outer periphery. According to an exemplary embodiment, a maximum width of an inside part of each of the recesses is larger than that of an open part of the recess.

Embodiments of the present invention relate to a rotor of an axial gap motor, including the above yoke and a bonded magnet provided in the recesses of the yoke.

Embodiments of the present invention relate to an axial gap motor, including the above rotor.

According to the embodiments above, it is possible to provide a highly durable rotor of an axial gap motor which makes it possible to reduce defects such as peeling and cracking of a bonded magnet even in a cold-hot environment, as well as a yoke suitable for the rotor of an axial gap motor.

### BRIEF DESCRIPTION OF DRAWINGS

FIG. 1A is an external view of a yoke for a rotor of an axial gap motor according to an exemplary embodiment of the present disclosure. FIG. 1B is an external view of a rotor of an axial gap motor according to an exemplary embodiment of the present disclosure.

FIG. 2A shows top views of three rotors of axial gap motors according to exemplary embodiments of the present disclosure. FIG. 2B shows respective A-A cross-sectional views of the rotors.

FIG. 3 is an external view of an axial gap motor according to an exemplary embodiment of the present disclosure produced from a yoke for a rotor of an axial gap motor according to an exemplary embodiment of the present disclosure.

FIG. 4A is a top view of a rotor of an axial gap motor produced in Comparative Example 1. FIG. 4B is an A-A cross-sectional view of the rotor.

### DETAILED DESCRIPTION

Embodiments of the present invention are described in detail below. The following embodiments, however, are intended as examples to embody the technical idea of the present invention and are not intended to limit the scope of the present invention to the following embodiments. As used herein, the term “step” encompasses not only an independent step but also a step that may not be clearly distinguished from other steps, as long as a desired object of the step is achieved.

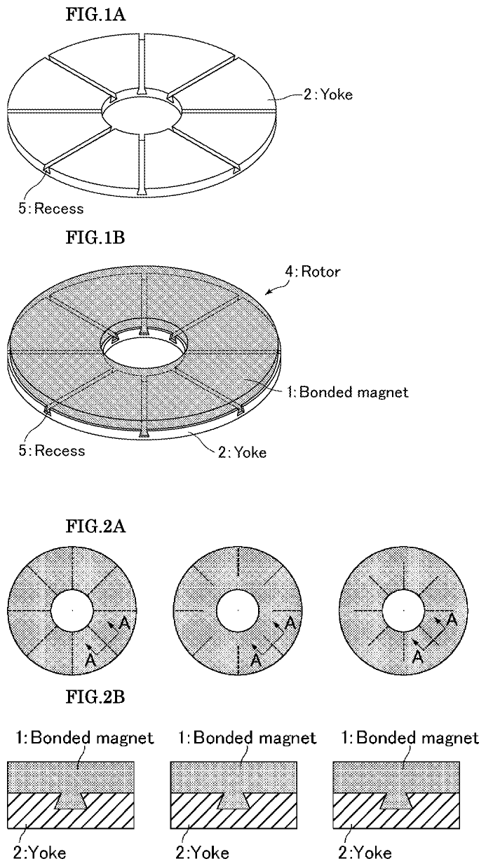

According to an exemplary embodiment of the present disclosure, a yoke for a rotor of an axial gap motor may have a plurality of recesses at a surface to be bonded to a bonded magnet, at least one of the recesses penetrating the yoke radially to the inner periphery or an outer periphery, wherein a maximum width of an inside part of at least one of the recesses is larger than that of an open part of the recess. According to an exemplary embodiment, each of the recesses penetrates the yoke radially to an inner periphery or an outer periphery. According to an exemplary embodiment, a maximum width of an inside part of each of the recesses is larger than that of an open part of the recess. FIG. 1A is an external view of a yoke 2 for a rotor of an axial gap motor of the present embodiment provided with eight recesses 5 having a substantially trapezoidal cross-sectional shape and penetrating the yoke radially from the inner periphery to the outer periphery. FIG. 1B is an external view of a rotor 4 of an axial gap motor of the present embodiment. Here, in FIG. 1B, the outer diameter of the bonded magnet 1 is slightly smaller than the outer diameter of the yoke 2, and the inner diameter of the bonded magnet 1 is slightly larger than the inner diameter of the yoke 2. FIG. 2A shows top views of rotors of axial gap motors according to exemplary embodiments of the present disclosure. FIG. 2B shows cross-sectional views of the rotors of axial gap motors according to exemplary embodiments of the present disclosure. It should be noted that in FIG. 1B, the bonded magnet is illustrated in a perspective manner for clarity of illustration.

The yoke 2 for a rotor 4 of an axial gap motor is in the form of a ring-shaped disc as shown in FIG. 1A. The outer diameter of the yoke 2 can be, for example, at least 20 mm but not more than 60 mm and may be at least 30 mm but not more than 50 mm. The inner diameter of the yoke 2 can be, for example, at least 5 mm but not more than 20 mm and may be at least 10 mm but not more than 15 mm. The thickness of the yoke 2 can be, for example, at least 1 mm but not more than 8 mm and may be at least 2 mm but not more than 6 mm.

The recesses 5 are portions to be filled with a bonded magnet 1 when a rotor 4 is prepared by inserting the yoke 2 for a rotor into a mold and injection-molding the bonded magnet 1 thereto. The recesses in which the maximum width of the inside part is larger than that of the open part show an anchoring effect to reduce peeling of the bonded magnet from the yoke and cracking of the bonded magnet even in a cold-hot environment.

The recesses are provided radially to the inner or outer periphery of the yoke. The term “radially” merely means that the recesses are provided from the inner periphery side to the outer periphery side, preferably from the center in the diameter direction of the disc. The recesses preferably do not penetrate the yoke in the thickness direction, so that the amount of the bonded magnet used can be reduced.

From the standpoint of the amount of the bonded magnet used and the durability of the bonded magnet, the maximum width of the open part of each recess is preferably at least 0.5 mm but not more than 4 mm, more preferably at least 1 mm but not more than 3 mm. From the standpoint of the amount of the bonded magnet used and the durability of the bonded magnet, the maximum width of the inside part of each recess is preferably at least 1 mm but less than 4.5 mm, more preferably at least 1.5 mm but less than 3.5 mm. From the standpoint of the amount of the bonded magnet used and the durability of the bonded magnet, the depth of each recess is preferably at least 0.5 mm but not more than 3 mm, more preferably at least 1.5 mm but not more than 2 mm, depending on the thickness of the yoke. The case where the recesses do not penetrate the yoke in the thickness direction means that the depth of each recess is smaller than the thickness of the yoke. The maximum width of the inside part of each recess is required to be larger than the maximum width of the open part thereof. From the standpoint of the amount of the bonded magnet used and the durability of the bonded magnet, the maximum width of the inside part is preferably at least 130% larger, more preferably at least 150% larger than that of the open part.

The recesses may penetrate the yoke radially to the inner periphery or the outer periphery. FIG. 2A shows top views of recesses penetrating the yoke radially to the inner and outer peripheries, recesses penetrating the yoke radially only to the outer periphery, and recesses penetrating the yoke radially only to the inner periphery. Here, the bonded magnets are illustrated in a perspective manner for clarity of illustration of the positions of the recesses. These three types of recesses may be present alone or in combination. When the recesses penetrate the yoke in any of the directions, distortion caused by the expansion and contraction of the bonded magnet due to changes in temperature can be alleviated, resulting in improved thermal shock resistance and therefore reduced peeling and cracking of the bonded magnet. In particular, at least one of the recesses preferably penetrates the yoke to both the inner periphery and the outer periphery in order to further alleviate distortion. According to an exemplary embodiment, each of the recesses penetrates the yoke to the inner periphery and the outer periphery.

The recesses may have any cross-sectional shape such as a substantially trapezoidal shape, a substantially circular shape, or a substantially elliptical shape.

A plurality of recesses are required. The number of recesses may be 16 or less, but from the standpoint of the amount of the bonded magnet used and the durability of the bonded magnet, it is preferably 8 or less, more preferably 4 or less, particularly preferably 2. Moreover, the recesses are preferably positioned such that the areas of the surface of the yoke divided by the recesses are substantially equal to each other.

The yoke may be made of any material such as stainless steel or a SS material (rolled steel for general structure). The surface of the yoke is preferably plated with a material such as zinc in order to provide an effect of reducing corrosion.

The recesses may be formed by any method such as by cutting the surface of the yoke with a dovetail cutter.

In the rotor of an axial gap motor of the present embodiment, a bonded magnet is provided in the recesses of the yoke. The rotor can be integrally molded by injection-molding a bonded magnet composition containing a magnetic powder and a thermoplastic resin onto the yoke. The outer diameter of the bonded magnet can be, for example, at least 20 mm but not more than 60 mm, and may be at least 30 mm but not more than 50 mm. The inner diameter of the bonded magnet can be, for example, at least 5 mm but not more than 20 mm, and may be at least 10 mm but not more than 18 mm. The thickness of the bonded magnet can be, for example, at least 1 mm but not more than 4 mm, and may be at least 2 mm but not more than 3 mm. Here, the thickness of the bonded magnet means the thickness of the bonded magnet excluding that at the recesses. From the standpoint of reducing the amount of the magnet used, it is preferred that the outer diameter of the bonded magnet provided in the recesses is smaller than the outer diameter of the yoke, and the inner diameter thereof is larger than the inner diameter of the yoke.

The magnetic powder used in the bonded magnet may be any magnetic powder such as a SmFeN, NdFeB, or SmCo rare earth magnetic powder. Among these rare earth magnetic powders, it is preferably a SmFeN magnetic powder because it has better thermal resistance than NdFeB and because it uses no rare metals, unlike SmCo. The SmFeN magnetic powder may be a nitride having a Th₂Zn₁₇-type crystal structure and containing the rare earth metal Sm, iron (Fe), and nitrogen (N) as represented by the general formula: SmₓFe_{100-x-y}N_{y}, wherein the value “x” representing the atomic percentage of the rare earth metal Sm is in the range of at least 8.1% but not more than 10%; the value “y” representing the atomic percentage of N is in the range of at least 13.5% but not more than 13.9%; and the balance is mainly Fe. Moreover, the magnetic powder may be a combination of a SmFeN magnetic powder with a NdFeB or SmCo rare earth magnetic powder or a ferrite magnetic powder.

The SmFeN magnetic powder can be produced as described in JP 3698538 B, for example. The thus produced SmFeN magnetic powder can suitably have an average particle size of at least 2 μm but not more than 5 μm with a standard deviation of 1.5 or less.

On the other hand, the NdFeB magnetic powder can be produced by an HDDR process as described in JP 3565513 B, for example. The thus produced NdFeB magnetic powder can suitably have an average particle size of at least 40 μm but not more than 200 μm and a maximum energy product of 34 to 42 MGOe (270 to 335 kJ/m³). Moreover, the SmCo magnetic powder can be produced as described in JP 3505261 B, for example, and can have an average particle size of at least 10 μm but not more than 30 μm.

The average particle size of the magnetic powder is preferably 10 μm or less, more preferably at least 1 μm but not more than 5 μm. With an average particle size of more than 10 μm, the bonded magnet may have poor appearance due to defects such as irregularities and cracks in the surface thereof. Conversely, with an average particle size of less than 1 μm, the magnetic powder may be expensive. Herein, the average particle size is defined as the particle size corresponding to the 50th percentile by volume from the smallest particle size in a particle size distribution.

The surface of the magnetic material may be treated with a silane coupling agent. Surface treatment with a material such as a silane coupling agent can reduce an increase in viscosity during injection molding.

The silane coupling agent is preferably one represented by the general formula: X—Si—(OR)ₙ wherein X is an alkyl group terminated with a polar group, R is an alkyl group having at least 1 but not more than 3 carbons, n is an integer of at least 1 but not more than 3, and the polar group in X is an amino, ureido, epoxy, thiol, or methacryloxy group. When the thermoplastic resin used is a nylon resin, the silane coupling agent is preferably one having an amino group with high affinity for the nylon resin, particularly preferably 3-aminopropyltrimethoxysilane, 3-aminopropyltriethoxysilane, 3-(2-aminoethyl)aminopropyltrimethoxysilane, or 3-(2-aminoethyl)aminopropylmethyltriethoxysilane.

The thermoplastic resin used in the bonded magnet may be any thermoplastic resin, and examples include polypropylene, polyethylene, polyvinyl chloride, polyester, polyamide, polycarbonate, polyphenylene sulfide, and acrylic resins. Among these, polypropylene or polyamide resins are preferable because they are crystalline resins having a relatively low melting point and a low water absorption rate and thus show good moldability. Particularly preferred among the polyamide resins is polyamide 12. Moreover, these resins may be used in admixture as appropriate. The amount of the thermoplastic resin(s) based on the total magnet is not limited, but is preferably at least 3% by mass but not more than 20% by mass, more preferably at least 5% by mass but not more than 15% by mass. With an amount of less than 3% by mass, fluidity may significantly decrease, resulting in difficulty in injection molding. With an amount of more than 20% by mass, a magnetic flux density sufficient for a magnet application may not be obtained.

The bonded magnet may contain components generally incorporated in a bonded magnet, such as an antioxidant, a lubricant, and a heavy metal deactivator. Moreover, the magnetic powder used in the present embodiment is preferably subjected to surface treatments to improve oxidation resistance, water resistance, wettability with the resin, and chemical resistance. These treatments may be used in combination as needed. The surface treatments may be carried out by a wet process, a dry process using a mixer or the like, a plating process, or a deposition process as appropriate. Moreover, additional agents such as a weathering agent, a plasticizer, a flame retardant, and an antistatic agent may be added as needed.

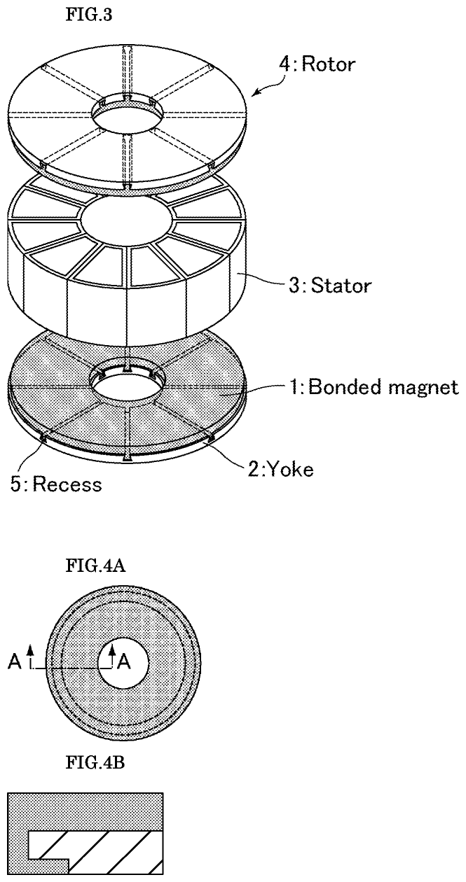

The rotor of an axial gap motor of the present embodiments may be combined with a stator to produce an axial gap motor. The motor can be used in, for example, a water pump, a fuel pump, or a fan of an in-vehicle inverter or a radiator. FIG. 3 is an external view of an axial gap motor with a rotor 4 of according to an exemplary embodiment of the present disclosure. In FIG. 3, the yoke 2 of the rotor 4 depicted above the stator 3 is illustrated in a perspective manner, and the bonded magnet 1 of the rotor 4 depicted below the stator 3 is illustrated in a perspective manner.

### EXAMPLES

The present invention is described in detail below with reference to examples. The present invention is not limited to these examples.

### PREPARATION EXAMPLE

### Bonded Magnet Composition

An amount of 91% by mass of a samarium-iron-nitrogen magnetic powder (average particle size 3 μm) was mixed with 8.3% by mass of a polypropylene resin powder, 0.6% by mass of an antioxidant powder, and 0.1% by mass of a lubricant in a mixer. Then, the powder mixture was introduced and kneaded at 230° C. in a twin screw kneader to obtain a kneaded mixture. The kneaded mixture was cooled and then cut into an appropriate size to obtain a bonded magnet composition.

### Example 1

A disc-shaped yoke made of a cold rolled steel plate (SPCC) and having an outer diameter of 50 mm, an inner diameter of 15 mm, and a thickness of 2 mm was processed using a carbide solid angular cutter for 0 ring (Eikosha Co., Ltd., dovetail cutter, flute length 1.5 mm, outer diameter 1.77 m, single angle) 15° to equally form eight radial undercuts as shown in FIG. 1A. The resulting recesses had a substantially trapezoidal cross-sectional shape, a width of the open part of 1.0 mm, a maximum width of the inside part of 1.8 mm, and a depth of 1.5 mm. The bonded magnet composition obtained in the preparation example was injection-molded onto the recess-forming surface of the yoke. The shape of the produced bonded magnet had an outer diameter of 49 mm, an inner diameter of 16 mm, and a thickness of 2 mm. In the thus-prepared rotor, the yoke and the bonded magnet were different in diameter, and the diameters of the inner and outer peripheries of the bonded magnet were smaller by 0.5 mm than the respective diameters of the yoke.

### Examples 2 to 5

Yokes were prepared as in Example 1, except that the numbers of recesses were changed as shown in Table 1.

### Comparative Example 1

A disc-shaped yoke made of a cold rolled steel plate (SPCC) and having an outer diameter of 50 mm, an inner diameter of 15 mm, and a thickness of 2 mm was processed such that the width of the upper portion (extending 1 mm in the thickness direction) of the yoke was 47 mm and the width of the lower portion (extending 1 mm in the thickness direction) of the yoke was 43 mm, as shown in FIG. 4B. The bonded magnet composition obtained in the preparation example was injection-molded onto the resulting yoke. The shape of the produced bonded magnet had an outer diameter of 49 mm, an inner diameter of 16 mm, and a thickness of 2 mm.

### Thermal Shock Resistance Test

A thermal shock resistance test was performed where each cycle consisted of −30° C. for 1 hour followed by 120° C. for 2 hours. The sample was taken out of the testing machine after each cycle to determine the occurrence of peeling and cracking of the bonded magnet portion of the bonded magnet composite. The results are shown in Table 1.

TABLE 1

| | | | Number of cycles |
|---|---|---|---|
| | Number of | Amount of bonded | of thermal shock |
| | recesses | magnet used (g) | resistance test |
| Example 1 | 8 | 10.3 | 542 |
| Example 2 | 2 | 9.8 | 720 |
| Example 3 | 4 | 10.0 | 630 |
| Example 4 | 6 | 10.1 | 560 |
| Example 5 | 12 | 10.5 | 480 |
| Comparative | — | 12.6 | 10 |
| Example 1 | | | |

The rotor produced in Comparative Example 1 exhibited a crack in the bonded magnet after only 10 cycles. In contrast, the rotors produced in Examples 1 to 5 did not exhibit peeling or cracking of the bonded magnet after at least 480 cycles. In particular, the rotors with a smaller number of recesses were better as they used a smaller amount of the bonded magnet and had more cycles before the bonded magnet was peeled or cracked.

The rotor of the present disclosure does not exhibit peeling of the bonded magnet from the yoke or cracking of the bonded magnet even in a severe use environment and has high durability. Moreover, the yoke of the present disclosure is suitable as a rotor of an axial gap motor. A rotor with the yoke is suitable for use in an axial gap motor.

What is claimed is:

1. A yoke for a rotor of an axial gap motor, comprising a plurality of recesses at a surface to be bonded to a bonded magnet,
at least one of the recesses penetrating the yoke radially to an inner periphery or an outer periphery,
wherein a maximum width of an inside part of at least one of the recesses is larger than that of an open part of the recess.

2. The yoke for a rotor of an axial gap motor according to claim 1,
wherein at least one of the recesses penetrates the yoke to the inner periphery and the outer periphery.

3. The yoke for a rotor of an axial gap motor according to claim 1,
wherein at least one of the recesses has a substantially trapezoidal cross-sectional shape, a substantially circular cross-sectional shape, or a substantially elliptical cross-sectional shape.

4. The yoke for a rotor of an axial gap motor according to claim 2,
wherein at least one of the recesses has a substantially trapezoidal cross-sectional shape, a substantially circular cross-sectional shape, or a substantially elliptical cross-sectional shape.

5. A rotor of an axial gap motor, comprising
the yoke according to claim 1, and
a bonded magnet provided in the recesses of the yoke.

6. A rotor of an axial gap motor, comprising
the yoke according to claim 2, and
a bonded magnet provided in the recesses of the yoke.

7. A rotor of an axial gap motor, comprising
the yoke according to claim 3, and
a bonded magnet provided in the recesses of the yoke.

8. A rotor of an axial gap motor, comprising
the yoke according to claim 4, and
a bonded magnet provided in the recesses of the yoke.

9. An axial gap motor, comprising the rotor according to claim 5.

10. An axial gap motor, comprising the rotor according to claim 6.

11. An axial gap motor, comprising the rotor according to claim 7.

12. An axial gap motor, comprising the rotor according to claim 8.

13. The yoke for a rotor of an axial gap motor according to claim 1,
wherein each of the recesses penetrates the yoke radially to the inner periphery or the outer periphery.

14. The yoke for a rotor of an axial gap motor according to claim 1,
wherein a maximum width of an inside part of each of the recesses is larger than that of an open part of the recess.

15. The yoke for a rotor of an axial gap motor according to claim 1,
wherein each of the recesses penetrates the yoke to the inner periphery and the outer periphery.

16. The yoke for a rotor of an axial gap motor according to claim 1,
wherein each of the recesses has a substantially trapezoidal cross-sectional shape, a substantially circular cross-sectional shape, or a substantially elliptical cross-sectional shape.
